(19) United States
(12) Patent Application Publication
(10) Pub. No.: US 2018/0369902 A1
(43) Pub. Date: Dec. 27, 2018

(54) FE-BASED AMORPHOUS ALLOY RIBBON

(71) Applicant: HITACHI METALS, LTD., Minato-ku, Tokyo (JP)

(72) Inventor: Jun SUNAKAWA, Yasugi-shi, Shimane (JP)

(21) Appl. No.: 15/778,627

(22) PCT Filed: Nov. 2, 2016
(86) PCT No.: PCT/JP2016/082692

§ 371 Date: May 24, 2018

(30) Foreign Application Priority Data
Nov. 26, 2015 (JP) 2015-230817

(51) Int. Cl. B22D 11/06; B22D 11/00; C22C 45/02; H01F 1/153

(52) U.S. Cl. CPC B22D 11/0611; B22D 11/001; C22C 2202/02; H01F 1/153; C22C 2200/02; C22C 45/02

(57) ABSTRACT

The invention provides an Fe-based amorphous alloy ribbon having a thickness of from 10 μm to 30 μm, in which a roughness curve of a central part in a ribbon width direction of the free solidified surface satisfies Rp≤3.0, Rv≤3.0, 7≤Pn≤30, 7≤Vn≤30, 0.9≤(V_{A}/P_{A})<1.4, and the like, the roughness curve being measured according to JIS B 0601: 2013 by applying 20 mm in a ribbon length direction as a reference length and taking 0.8 mm as a cut-off value. Rp represents a maximum profile peak height (μm), Rv represents a maximum profile valley depth (μm), Pn represents a number of profile peaks having a height of from 0.5 μm to 3.0 μm, Vn represents a number of profile valleys having a depth of from 0.5 μm to 3.0 μm, P_{A} represents an average of heights of five profile peaks from a highest profile peak to a fifth highest profile peak, and V_{A} represents an average of depths of five profile valleys from a deepest profile valley to a fifth deepest profile valley.

### TECHNICAL FIELD

The present invention relates to an Fe-based amorphous alloy ribbon.

### BACKGROUND ART

An Fe-based amorphous alloy ribbon (Fe-based amorphous alloy thin strip) is becoming more popular as a material for an iron core of a transformer.

As an example of an Fe-based amorphous alloy ribbon, a rapidly quenched Fe-based soft magnetic alloy ribbon having waveform unevenness on a free surface, the waveform unevenness having width troughs arranged at approximately regular intervals in the longitudinal direction, wherein the mean amplitude of the troughs is 20 mm or less, is known (see, for example, Patent Document 1 described below).
Patent Document 1: International Publication WO 2012/102379

### SUMMARY OF INVENTION

### Technical Problem

From the viewpoints of reducing the noise of a transformer produced by using an Fe-based amorphous alloy ribbon (specifically, noise due to magnetostriction vibration during the operation of the transformer) and the like, reduction of excitation power in an Fe-based amorphous alloy ribbon has been required.

The invention is made in consideration of the foregoing, and it is an object of the invention to provide an Fe-based amorphous alloy ribbon with reduced excitation power.

### Solution to Problem

After diligently studying the problems, the present inventors have found that the shape of a roughness curve of a free solidified surface of an Fe-based amorphous alloy ribbon has correlation with the excitation power in the Fe-based amorphous alloy ribbon. Based on this finding, the invention has been accomplished.

Namely, specific means for addressing the above problems are as follows.

<1> An Fe-based amorphous alloy ribbon having a free solidified surface, wherein:

the ribbon has a thickness of from 10 μm to 30 μm, and

a roughness curve of a central part in a ribbon width direction of the free solidified surface satisfies the following Equation (1) to Equation (5), the roughness curve being measured according to JIS B 0601:2013 by applying 20 mm in a ribbon length direction as a reference length and taking 0.8 mm as a cut-off value.

Rp≤3.0 Equation (1)

Rv≤3.0 Equation (2)

7≤Pn≤30 Equation (3)

7≤Vn≤30 Equation (4)

0.9≤(V_{A}/P_{A})<1.4 Equation (5)

[In Equation (1), Rp represents a maximum profile peak height (μm).

In Equation (2), Rv represents a maximum profile valley depth (μm).

In Equation (3), Pn represents a number of profile peaks that are included in the roughness curve and have a height of from 0.5 μm to 3.0 μm.

In Equation (4), Vn represents a number of profile valleys that are included in the roughness curve and have a depth of from 0.5 μm to 3.0 μm.

In Equation (5), P_{A} represents an average (μm) of heights of five profile peaks from a highest profile peak to a fifth highest profile peak, and V_{A} represents an average (μm) of depths of five profile valleys from a deepest profile valley to a fifth deepest profile valley.]

<2> The Fe-based amorphous alloy ribbon according to <1>, wherein V_{A} is from 1.1 μm to 2.0 μm.

<3> The Fe-based amorphous alloy ribbon according to <1> or <2> having a width of from 100 mm to 500 mm.

<4> The Fe-based amorphous alloy ribbon according to any one of <1> to <3>, wherein a content of Si is from 3 atom % to 10 atom %, a content of B is from 10 atom % to 15 atom %, and a content of C is 0.5 atom % or less when a total content of Fe, Si, and B is 100 atom %, with the remainder consisting of Fe and impurities.

### Advantageous Effects of Invention

According to the invention, an Fe-based amorphous alloy ribbon with reduced excitation power may be provided.

### BRIEF DESCRIPTION OF DRAWINGS

FIG. 1 is a conceptual cross-sectional view schematically showing an example of an Fe-based amorphous alloy ribbon production apparatus based on a single-roll method, the production apparatus being suitable for an embodiment of the invention.

FIG. 2 is a roughness curve of Example 1.

FIG. 3 is a roughness curve of Comparative Example 1.

FIG. 4 is a roughness curve of Comparative Example 2.

### DESCRIPTION OF EMBODIMENTS

Hereinafter, embodiments of the invention will be described.

In this specification, a numeral range described by using the term “to” represents a range including numeral values described in front of and behind “to” as the lower limit value and the upper limit value.

Further, in this specification, the “free solidified surface” and the “free surface” have the same definition.

Further, in this specification, an Fe-based amorphous alloy ribbon refers to a ribbon (thin strip) made from an Fe-based amorphous alloy.

Furthermore, in this specification, an Fe-based amorphous alloy refers to an amorphous alloy in which the content (atom %) of Fe (iron) is the largest, among the contents of metal elements incorporated therein.

[Fe-Based Amorphous Alloy Ribbon]

The Fe-based amorphous alloy ribbon according to the embodiment of the invention is an Fe-based amorphous alloy ribbon having a free solidified surface, in which the ribbon has a thickness of from 10 μm to 30 μm, and a roughness curve of a central part in the ribbon width direction of the free solidified surface satisfies the following Equation (1) to Equation (5), the roughness curve being measured according to JIS B 0601:2013 by applying 20 mm in the ribbon length direction as a reference length and taking 0.8 mm as a cut-off value.

Rp≤3.0 Equation (1)

Rv≤3.0 Equation (2)

7≤Pn≤30 Equation (3)

7≤Vn≤30 Equation (4)

0.9≤(V_{A}/P_{A})<1.4 Equation (5)

In Equation (1), Rp represents a maximum profile peak height (μm).

In Equation (2), Rv represents a maximum profile valley depth (μm).

In Equation (3), Pn represents a number of profile peaks that are included in the roughness curve and have a height of from 0.5 μm to 3.0 μm.

In Equation (4), Vn represents a number of profile valleys that are included in the roughness curve and have a depth of from 0.5 μm to 3.0 μm.

In Equation (5), P_{A} represents an average (μm) of heights of five profile peaks from a highest profile peak to a fifth highest profile peak, and V_{A} represents an average (μm) of depths of five profile valleys from a deepest profile valley to a fifth deepest profile valley.

The present inventors have found that the excitation power is reduced in the Fe-based amorphous alloy ribbon (hereinafter also referred to simply as “alloy ribbon”) according to the embodiment of the invention.

It is thought that the roughness curve in the embodiment of the invention reflects the micro rugged shape of the free solidified surface of the alloy ribbon. The present inventors have found that the excitation power in the alloy ribbon is reduced by adjusting the micro rugged shape of the free solidified surface to be within a specific range, specifically, so that the roughness curve satisfies Equation (1) to Equation (5).

Hereinafter, the technical meanings of Equation (1) to Equation (5) will be described.

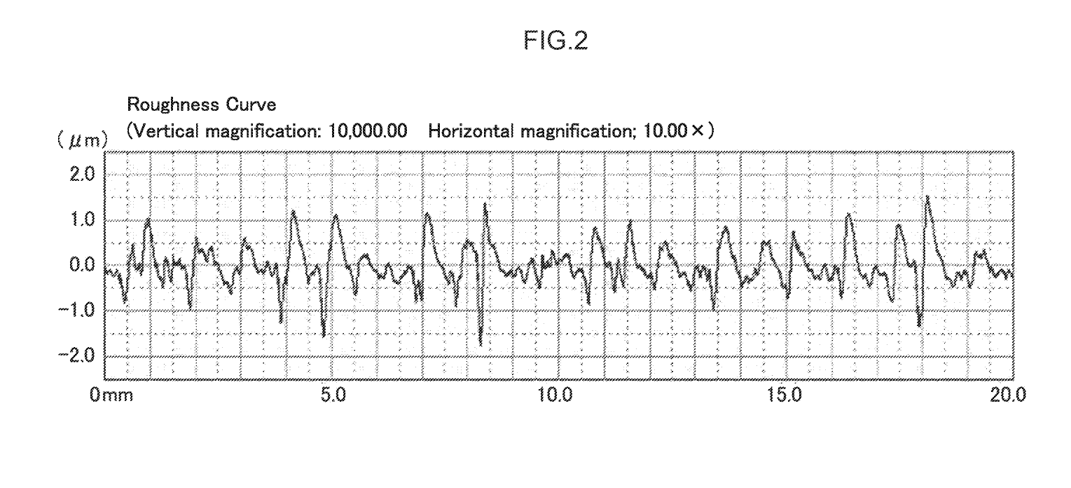

Roughly speaking, Equation (1) to Equation (5) indicate that the free solidified surface of the alloy ribbon has a certain degree of definite (moderate) rugged shape (see, for example, FIG. 2).

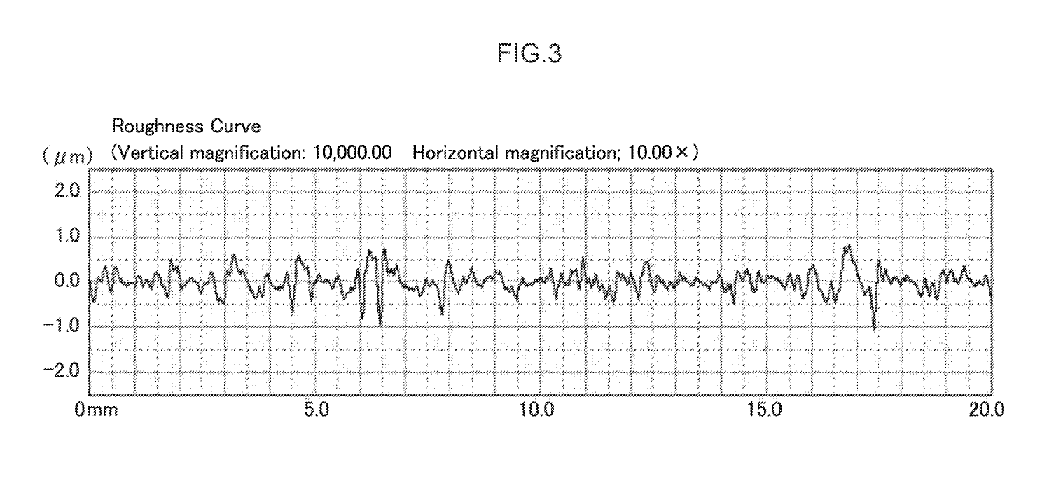

Regarding the free solidified surface in the embodiment of the invention, it does not mean that the flatter the better. When the free solidified surface of an alloy ribbon becomes too flat and the rugged shape becomes unclear, there are cases in which the excitation power increases (see, for example, FIG. 3).

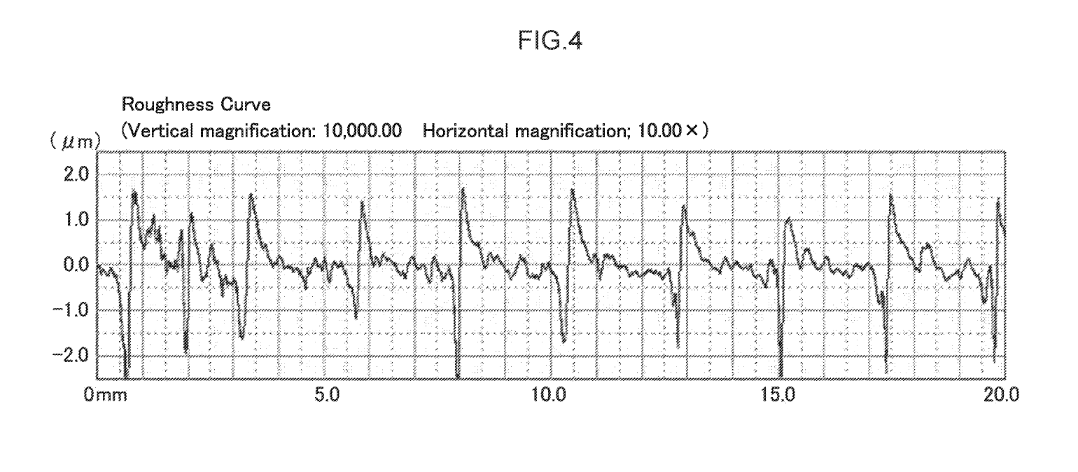

Meanwhile, when the rugged shape of the free solidified surface becomes too clear, there are cases in which the excitation power increases (see, for example, FIG. 4).

Rp≤3.0 Equation (1):

Equation (1) indicates that the maximum profile peak height Rp is 3.0 μm or less. In other words, Equation (1) indicates that the heights of all the profile peaks incorporated in the roughness curve are 3.0 μm or less.

A profile peak having a height of more than 3.0 μm increases the excitation power.

Equation (1) specifies that a profile peak having a height of more than 3.0 μm, which increases the excitation power, does not exist in the roughness curve.

Rv≤3.0 Equation (2):

Equation (2) indicates that the maximum profile valley depth Rv is 3.0 μm or less. In other words, Equation (2) indicates that the depths of all the profile valleys incorporated in the roughness curve are 3.0 μm or less.

A profile valley having a depth of more than 3.0 μm increases the excitation power.

Equation (2) specifies that a profile valley having a depth of more than 3.0 μm, which increases the excitation power, does not exist in the roughness curve.

7≤Pn≤30 Equation (3):

In Equation (3), Pn represents the number of profile peaks, which are included in the roughness curve and have a height of from 0.5 μm to 3.0 μm.

Equation (3) specifies that the number (Pn) of “profile peaks having a height of from 0.5 μm to 3.0 μm” is not too large and not too small.

When the roughness curve satisfies the left side (7≤Pn) of Equation (3), the excitation power is reduced.

Meanwhile, when the roughness curve satisfies the right side (Pn≤30) of Equation (3), the productivity (suitability for production) of the alloy ribbon is excellent. Pn is preferably 25 or less.

Further, that the roughness curve satisfies 7≤Pn contributes not only to the reduction of excitation power but also to the reduction of core loss (see Comparative Examples 1, 101, and 201).

7≤Vn≤30 Equation (4):

In Equation (4), Vn represents the number of profile valleys, which are included in the roughness curve and have a depth of from 0.5 μm to 3.0 μm.

Equation (4) specifies that the number (Vn) of “profile valleys having a depth of from 0.5 μm to 3.0 μm” is not too large and not too small.

When the roughness curve satisfies the left side (7≤Vn) of Equation (4), the excitation power is reduced.

Meanwhile, when the roughness curve satisfies the right side (Vn≤30) of Equation (4), the productivity (suitability for production) of the alloy ribbon is excellent. Vn is preferably 25 or less.

Further, that the roughness curve satisfies 7≤Vn contributes not only to the reduction of excitation power but also to the reduction of core loss (see Comparative Examples 1, 101, and 201).

0.9≤(V_{A}/P_{A})<1.4 Equation (5):

In Equation (5), P_{A} represents the average of heights of five profile peaks from the highest profile peak to the fifth highest profile peak (hereinafter also referred to as the “mean height of profile peaks”), and V_{A} represents the average of depths of five profile valleys from the deepest profile valley to the fifth deepest profile valley (hereinafter also referred to as the “mean depth of profile valleys”).

Roughly speaking, Equation (5) specifies the balance between the mean height of profile peaks and the mean depth of profile valleys in the roughness curve.

The left side (0.9≤(V_{A}/P_{A})) of Equation (5) indicates that the mean depth of profile valleys is deep at a certain level (the mean depth of profile valleys is 0.9 times or more as large as the mean height of profile peaks). Accordingly, the alloy ribbon exhibits excellent productivity (suitability for production).

The right side ((V_{A}/P_{A})<1.4) of Equation (5) indicates that the mean depth of profile valleys is shallow at a certain level (the mean depth of profile valleys is less than 1.4 times as large as the mean height of profile peaks). Accordingly, the excitation power is reduced (see Comparative Examples 2, 102, and 202). (V_{A}/P_{A}) is more preferably 1.2 or less.

Concerning the right side ((V_{A}/P_{A})<1.4) of Equation (5), in an alloy ribbon (a rapidly quenched Fe-based soft magnetic alloy ribbon) described in Patent Document 1, it is thought that the value of (V_{A}/P_{A}) exceeds 2, when estimated from FIG. 2 of the same document. It is thought that this is because, in this document, a peripheral surface of a chill roll is polished by using a wire brush made of metal such as stainless steel (see paragraph 0038 in the same document). In detail, it is thought that, by polishing the peripheral surface of the chill roll using a wire brush made of metal, deep abrasions occur on the peripheral surface of the chill roll, and a molten alloy penetrates into these deep abrasions. Further, it is thought that, since the thickness of the ribbon is thin, deep valleys are formed on the surface (namely, the free surface of the ribbon) opposite to the contact surface (the roll surface of the ribbon) of the peripheral surface.

As described above, in the alloy ribbon according to the embodiment of the invention, the roughness curve satisfies Equation (1) to Equation (5) and thus, the excitation power is reduced. By the satisfaction of “7≤Pn” and “7≤Vn”, the core loss is also reduced.

It is preferable that a wave-like rugged shape is formed on the free solidified surface of the alloy ribbon according to the embodiment of the invention.

Here, a wave-like rugged shape is a shape that can be formed on a free solidified surface of an alloy ribbon according to a single-roll method. With regard to the wave-like rugged shape, description in Patent Document 1 and description in the following Non-Patent Document 1 can be referred to.
Non-Patent Document 1: CORMAC J. BYRNE et al. “Capillary Puddle Vibrations Linked to Casting-Defect Formation in Planar-Flow Melt Spinning”, Metallurgical and Materials Transactions, vol. 37B, pages 445 to 456 (2006).

The thickness of the alloy ribbon according to the embodiment of the invention is from 10 μm to 30 μm.

When the thickness is 10 μm or more, the mechanical strength of the alloy ribbon is ensured, and rapture of the alloy ribbon is suppressed. Accordingly, continuous casting of the alloy ribbon becomes possible. The thickness of the alloy ribbon is preferably 15 μm or more.

Further, when the thickness is 30 μm or less, a stable amorphous state can be obtained in the alloy ribbon. The thickness of the alloy ribbon is more preferably 28 μm or less.

In the embodiment of the invention, from the viewpoint of further reducing the excitation power, P_{A} (the average of heights of five profile peaks from the highest profile peak to the fifth highest profile peak) is preferably from 1.1 μm to 2.0 μm, more preferably from 1.2 μm to 1.8 μm, and particularly preferably from 1.3 μm to 1.6 μm.

The width (namely, the length in the width direction) of the alloy ribbon according to the embodiment of the invention is preferably from 100 mm to 500 mm.

When the width of the alloy ribbon is 100 mm or more, a practical transformer having a large capacity can be obtained.

Further, when the width of the alloy ribbon is 100 mm or more, the need to reduce the excitation power increases. Accordingly, the alloy ribbon according to the embodiment of the invention, with which the excitation power is to be reduced, is particularly preferable as an alloy ribbon having a wide width, being as wide as 100 mm or more.

Meanwhile, when the width of the alloy ribbon is 500 mm or less, the productivity (suitability for production) of the alloy ribbon is excellent. From the viewpoint of the productivity (suitability for production) of the alloy ribbon, the width of the alloy ribbon is more preferably 400 mm or less, still more preferably 300 mm or less, and particularly preferably 250 mm.

The composition of the Fe-based amorphous alloy in the embodiment of the invention is not particularly limited as far as the content (atom %) of Fe (iron) is the largest, among the contents of metal elements incorporated therein.

The Fe-based amorphous alloy contains at least Fe (iron), but it is preferable to further contain Si (silicon) and B (boron). The Fe-based amorphous alloy may further contain C (carbon), which is an element incorporated in the source materials for a molten alloy, such as pure iron.

The Fe-based amorphous alloy may be an Fe-based amorphous alloy in which the content of Fe is from 78 atom % to 83 atom %, the content of Si is from 3 atom % to 10 atom %, the content of B is from 10 atom % to 15 atom %, and the content of C (carbon) is 0.5 atom % or less when the total content of Fe, Si, and B is 100 atom %, with the remainder consisting of impurities.

When the content of Fe is 78 atom % or more, the saturation flux density of the alloy ribbon becomes higher, and thus an increase in size or an increase in weight of a magnetic core to be produced by using the alloy ribbon is further suppressed.

When the content of Fe is 83 atom % or less, a decrease in Curie point of the alloy and a decrease in the crystallization temperature are further suppressed, and thus the stability of magnetic properties of the magnetic core is further enhanced.

Further, when the content of C (carbon) is 0.5 atom % or less, embrittlement of the alloy ribbon is further suppressed.

The content of C (carbon) is preferably from 0.1 atom % to 0.5 atom %.

When the content of C (carbon) is 0.1 atom % or more, productivity of the molten alloy and productivity of the alloy ribbon are excellent.

More preferable examples of the Fe-based amorphous alloy include:

an Fe-based amorphous alloy in which the content of Fe is from 78.5 atom % to 80.5 atom %, the content of Si is from 8.5 atom % to 9.5 atom %, the content of B is from 11.0 atom % to 12.0 atom %, and the content of C is 0.5 atom % or less when the total content of Fe, Si, and B is 100 atom %, with the remainder consisting of impurities;

an Fe-based amorphous alloy in which the content of Fe is from 78.8 atom % to 82.4 atom %, the content of Si is from 6.1 atom % to 8.0 atom %, the content of B is from 11.5 atom % to 13.2 atom %, and the content of C is 0.5 atom % or less when the total content of Fe, Si, and B is 100 atom %, with the remainder consisting of impurities; and

an Fe-based amorphous alloy in which the content of Fe is from 80.5 atom % to 82.5 atom %, the content of Si is from 3.5 atom % to 4.5 atom %, the content of B is from 14.0 atom % to 15.0 atom %, and the content of C is 0.5 atom % or less when the total content of Fe, Si, and B is 100 atom %, with the remainder consisting of impurities.

In each of the Fe-based amorphous alloys described above, the content of C (carbon) is preferably from 0.1 atom % to 0.5 atom % when the total content of Fe, Si, and B is 100 atom %.

[Production Method of Fe-Based Amorphous Alloy Ribbon]

The production method of the Fe-based amorphous alloy ribbon according to the embodiment of the invention is not particularly limited as far as the method includes forming a free solidified surface. A single-roll method is preferable.

A more preferable example of the production method of the Fe-based amorphous alloy ribbon according to the embodiment of the invention is

a production method using an Fe-based amorphous alloy ribbon production apparatus equipped with

a chill roll in which a coated film of a molten alloy, which is a source material for the Fe-based amorphous alloy ribbon, is formed on the peripheral surface and the coated film is cooled on the peripheral surface to form an Fe-based amorphous alloy ribbon,

a molten metal nozzle that discharges the molten alloy toward the peripheral surface of the chill roll,

a peeling means that peels off the Fe-based amorphous alloy ribbon from the peripheral surface of the chill roll, and

a polishing means which is provided between the peeling means and the molten alloy nozzle in the periphery of the chill roll and is used for polishing the peripheral surface of the chill roll; wherein

the production method includes forming a coated film of the molten alloy on the peripheral surface of the chill roll that has been subjected to polishing by using the polishing means, and then cooling the coated film on the peripheral surface, to obtain an Fe-based amorphous alloy ribbon.

In the preferable production method described above, by adjusting at least one of the production conditions that exert influence on the rugged shape to be formed on the free solidified surface, an alloy ribbon that satisfies Equation (1) to Equation (5) can be obtained.

Preferable ranges of the production conditions are described below.

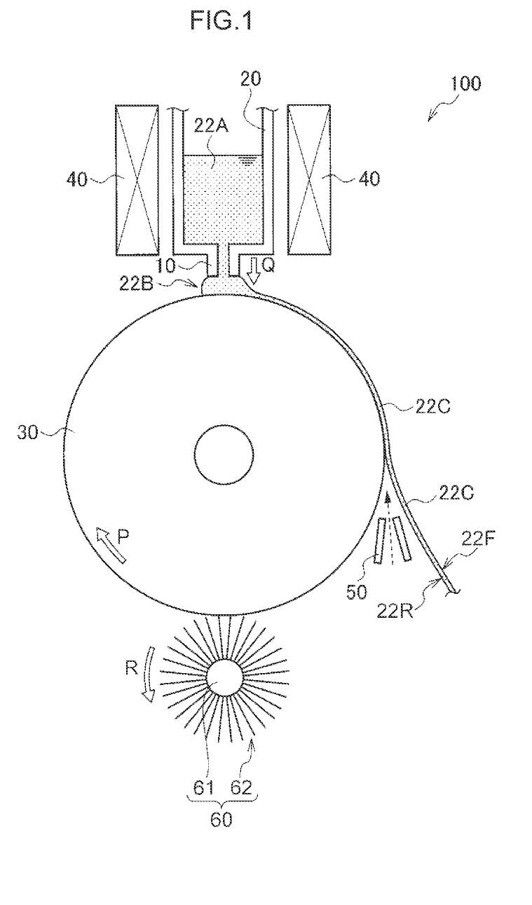

FIG. 1 is a conceptual cross-sectional view schematically showing an example of an Fe-based amorphous alloy ribbon production apparatus based on a single-roll method, the production apparatus being suitable for the embodiment of the invention.

As shown in FIG. 1, an alloy ribbon production apparatus 100, which is an Fe-based amorphous alloy ribbon production apparatus, is provided with a crucible 20 provided with a molten metal nozzle 10, and a chill roll 30 whose peripheral surface faces a tip of the molten metal nozzle 10.

FIG. 1 shows a cross section of the alloy ribbon production apparatus 100 sectioned by a plane perpendicular to the axial direction of the chill roll 30 and to the width direction of an alloy ribbon 22C. Here, the alloy ribbon 22C is an example of the Fe-based amorphous alloy ribbon according to the embodiment of the invention. Further, the axial direction of the chill roll 30 and the width direction of the alloy ribbon 22C are identical.

The crucible 20 has an internal space that can accommodate a molten alloy 22A, which is a source material for an alloy ribbon 22C, and the internal space is communicated with a molten metal flow channel in a molten metal nozzle 10. As a result, a molten alloy 22A accommodated in the crucible 20 can be discharged through the molten metal nozzle 10 to a chill roll 30 (in FIG. 1, the discharge direction and the flow direction of the molten alloy 22A is represented by the arrow Q). A crucible 20 and a molten metal nozzle 10 may be configured as an integrated body or as separate bodies.

At least partly around a crucible 20, a high-frequency coil 40 is placed as a heating means. By this, a crucible 20 in a state accommodating a mother alloy of an alloy ribbon can be heated to form a molten alloy 22A in the crucible 20, or a molten alloy 22A supplied from the outside to the crucible 20 can be kept in a liquid state.

A molten metal nozzle 10 has an opening for discharging a molten alloy (a discharge port).

It is appropriate that the opening is a rectangular (slit shape) opening.

The length of a long side of a rectangular opening corresponds to the width of an amorphous alloy ribbon to be produced. The length of a long side of a rectangular opening is preferably from 100 mm to 500 mm, more preferably from 100 mm to 400 mm, still more preferably from 100 mm to 300 mm, and particularly preferably from 100 mm to 250 mm.

The distance (the closest distance) between the tip of the molten metal nozzle 10 and the peripheral surface of the chill roll 30 is so small that, when the molten alloy 22A is discharged through the molten metal nozzle 10, a puddle 22B (a molten metal puddle) is formed.

The chill roll 30 rotates axially in the direction of the rotational direction P.

A cooling medium such as water is circulated inside the chill roll 30, with which the coated film of a molten alloy formed on the peripheral surface of the chill roll 30 can be cooled. By cooling the coated film of the molten alloy, an alloy ribbon 22C (an Fe-based amorphous alloy ribbon) is formed.

Examples of the material of the chill roll 30 include Cu and Cu alloys (a Cu—Be alloy, a Cu—Cr alloy, a Cu—Zr alloy, a Cu—Cr—Zr alloy, a Cu—Ni alloy, a Cu—Ni—Si alloy, a Cu—Ni—Si—Cr alloy, a Cu—Zn alloy, a Cu—Sn alloy, a Cu—Ti alloy, and the like). From the viewpoint of having a high thermal conductivity, a Cu alloy is preferable, and a Cu—Be alloy, a Cu—Cr—Zr alloy, a Cu—Ni alloy, a Cu—Ni—Si alloy, or a Cu—Ni—Si—Cr alloy is more preferable.

Although there is no particular limitation as to the surface roughness of the peripheral surface of the chill roll 30, the arithmetic average roughness (Ra) of the peripheral surface of the chill roll 30 is preferably from 0.1 μm to 0.5 μm, and more preferably from 0.1 μm to 0.3 μm. When the arithmetic average roughness Ra of the peripheral surface of the chill roll 30 is 0.5 μm or less, the space factor in the production of a transformer using the alloy ribbon is further enhanced. When the arithmetic average roughness Ra of the peripheral surface of the chill roll 30 is 0.1 μm or more, adjustment of Ra becomes easier.

The arithmetic average roughness Ra means a surface roughness measured according to JIS B 0601:2013.

From the viewpoint of cooling power, the diameter of the chill roll 30 is preferably from 200 mm to 1000 mm, and more preferably from 300 mm to 800 mm.

The rotation speed of the chill roll 30 may be in a range ordinary set for a single-roll method. A circumferential speed of from 10 m/s to 40 m/s is preferable, and a circumferential speed of from 20 m/s to 30 m/s is more preferable.

The alloy ribbon production apparatus 100 is further equipped with a peeling gas nozzle 50, as a peeling means for peeling off the Fe-based amorphous alloy ribbon from the peripheral surface of the chill roll, at a downstream side of the molten metal nozzle 10 in the rotational direction of the chill roll 30 (hereinafter, also referred to simply as “the downstream side”).

In this example, by blowing a peeling gas through the peeling gas nozzle 50 in the direction (the direction of a dashed line arrow in FIG. 1) opposite to the rotational direction P of the chill roll 30, peeling of the alloy ribbon 22C from the chill roll 30 is performed. As the peeling gas, for example, a nitrogen gas or a high pressure gas such as compressed air can be used.

The alloy ribbon production apparatus 100 is further equipped with a polishing brush roll 60 as a polishing means for polishing the peripheral surface of the chill roll 30, at a downstream side of the peeling gas nozzle 50.

The polishing brush roll 60 includes a roll axis member 61 and a polishing brush 62 placed around the roll axis member 61. The polishing brush 62 is composed of numerous brush bristles.

By axially rotating the polishing brush roll 60 in the rotational direction R, the peripheral surface of the chill roll 30 is polished by using the brush bristles of the polishing brush 62.

The purpose of polishing by using the above polishing means (for example, polishing brush roll 60) is not necessarily limited to scrubbing the peripheral surface of the chill roll, and it could be that the purpose is to remove residues remained on the peripheral surface of the chill roll. It is preferable that the purpose of the above polishing is at least one of the following first purpose or the following second purpose.

The first purpose is to repair the deterioration in smoothness of the peripheral surface of the chill roll. In detail, when a molten alloy and a peripheral surface of a chill roll contact each other for the first time, there are cases in which a very small portion of the peripheral surface of the chill roll (for example, a Cu alloy) dissolves in the molten alloy and a micro recessed part is formed on the peripheral surface of the chill roll to deteriorate the smoothness of the peripheral surface of the chill roll. Deterioration in smoothness of the peripheral surface of the chill roll may cause deterioration in smoothness of the roll surface (the surface that has been in contact with the peripheral surface of the chill roll; hereinafter in the present specification, the same applies.) of the alloy ribbon to be produced. Also in a case in which the smoothness of the peripheral surface of the chill roll has been deteriorated, by the above polishing, a relatively projected part (namely, a part where the dissolution has been suppressed) relative to the above micro recessed part is removed, so that the deterioration in smoothness of the peripheral surface of the chill roll can be repaired. As a result, deterioration in smoothness of the roll surface of the alloy ribbon, which is caused by the deterioration in smoothness of the peripheral surface of the chill, can be suppressed.

The second purpose is to remove the residue (alloy) remained on the peripheral surface of the chill roll after peeling of an alloy ribbon. The molten alloy that has been discharged onto the peripheral surface of the chill roll is rapidly cooled to form an alloy ribbon, and thereafter, the alloy ribbon is peeled off from the peripheral surface of the chill roll. In this process, there are cases in which a portion of the alloy, which is the material of the alloy ribbon, does not peel off from the peripheral surface of the chill roll and remains as a residue, and this residue is fixed to the peripheral surface of the chill roll to form a projected part. Since casting of the alloy ribbon is performed continuously, the molten alloy is discharged again onto the peripheral surface of the chill roll, the peripheral surface having a projected part of the above residue formed thereon. As a result, in the roll surface of the alloy ribbon to be produced, there are cases in which a recessed part is formed at the position corresponding to the above projected part, to deteriorate smoothness of the roll surface of the alloy ribbon. Further, in a case in which the thermal conductivity of the residue (alloy) that forms the projected part is lower than the thermal conductivity of the peripheral surface (for example, a Cu alloy) of the chill roll, characteristics of rapid cooling by the chill roll is partially deteriorated in the above projected part, and there is concern that magnetic properties of the alloy ribbon may be deteriorated. Also in a case in which the residue remains on the peripheral surface of the chill roll after peeling of the alloy ribbon, the residue can be removed by the above polishing. As a result, deterioration in smoothness of the roll surface of the alloy ribbon, which is caused by the above residue, can be suppressed. Further, deterioration in magnetic properties of the alloy ribbon, which is caused by the above residue, can be suppressed.

Further, in this example, as shown in FIG. 1, the rotational direction R of the polishing brush roll is opposite to the rotational direction P of the chill roll (in FIG. 1, the rotational direction R is counterclockwise, and the rotational direction P is clockwise). In a case in which the rotational direction of a polishing brush roll is opposite to the rotational direction of a chill roll, a specific point in the peripheral surface of the chill roll and a specific brush bristle of the polishing brush roll move toward the same direction at the contact portion of the chill roll and the polishing brush roll.

In the embodiment of the invention, unlike the above example, the rotational direction of a polishing brush roll and the rotational direction of a chill roll may be identical. In a case in which the rotational direction of a polishing brush roll and the rotational direction of a chill roll are identical, a specific point in the peripheral surface of the chill roll and a specific brush bristle of the polishing brush roll move toward the opposite direction from each other at the contact portion of the chill roll and the polishing brush roll.

The alloy ribbon production apparatus 100 may be provided with other element (for example, a wind-up roll for reeling up the produced alloy ribbon 22C, a gas nozzle for blowing a CO₂ gas, an N₂ gas, or the like to the puddle 22B of a molten alloy or its vicinity, or the like) in addition to the elements described above.

Further, the basic configuration of the alloy ribbon production apparatus 100 may be similar to a configuration of an amorphous alloy ribbon production apparatus based on a conventional single-roll method (see, for example, International Publication WO 2012/102379, Japanese Patent No. 3494371, Japanese Patent No. 3594123, Japanese Patent No. 4244123, Japanese Patent No. 4529106, or the like).

Next, an example of a production method of the alloy ribbon 22C using the alloy ribbon production apparatus 100 will be described.

First, a molten alloy 22A as a source material for the alloy ribbon 22C is prepared in the crucible 20. The temperature of the molten alloy 22A is set as appropriate considering the composition of the alloy, and is, for example, from 1210° C. to 1410° C. and preferably from 1260° C. to 1360° C.

Next, the molten alloy is discharged through the molten metal nozzle 10 onto the peripheral surface of the chill roll 30, which rotates axially in the rotational direction P, and while forming a puddle 22B, a coated film of the molten alloy is formed. The coated film thus formed is cooled on the peripheral surface of the chill roll 30, to form an alloy ribbon 22C on the peripheral surface. Then, the alloy ribbon 22C formed on the peripheral surface of the chill roll 30 is peeled off from the peripheral surface of the chill roll 30 by blowing a peeling gas from the peeling gas nozzle 50 and reeled up on a wind-up roll (not shown in the figure) in a form of a roll for recovery.

Meanwhile, after the alloy ribbon 22C has been peeled off, the peripheral surface of the chill roll 30 is polished by using the polishing brush 62 of the polishing brush roll 60, which rotates axially in the rotational direction R. The molten alloy is discharged again onto the peripheral surface of the chill roll 30 that has been subjected to polishing.

The operations described above are carried out repeatedly and thus, a long alloy ribbon 22C is produced (casted) continuously.

By the production method according to the example described above, an alloy ribbon 22C, which is an example of the Fe-based amorphous alloy ribbon according to the embodiment of the invention, is produced.

The alloy ribbon 22C has a roll surface 22R, which is a surface that has been in contact with the peripheral surface of the chill roll 30, and a free solidified surface 22F, which is a surface (a surface opposite to the roll surface 22R) that has not been in contact with the peripheral surface of the chill roll 30.

The thickness of the alloy ribbon 22C is from 10 μm to 30 μm.

With regard to the alloy ribbon 22C, the roughness curve measured through scanning a part of the free solidified surface 22F satisfies Equation (1) to Equation (5).

Equation (1) to Equation (5) can be related to, for example, the feature of the polishing brush roll (the material, the shape, the size, the structure, or the like); the conditions for polishing the peripheral surface of the chill roll by using the polishing brush roll (for example, the speed of the polishing brush relative to the speed of the chill roll); the discharge pressure of the molten alloy; the distance between the molten metal nozzle tip and the peripheral surface of the chill roll; and the like.

First, the relationships between Equation (1) to Equation (5) and the feature of the polishing brush roll or the polishing conditions are described below.

As described above, the shape of a peripheral surface of a chill roll, onto which a molten alloy is to be applied (namely, a peripheral surface of a chill roll that has been subjected to polishing by using a polishing brush) directly influences on the shape of a roll surface of an alloy ribbon to be produced. However, in the embodiment of the invention, since the thickness of the alloy ribbon is extremely thin and is as thick as from 10 μm to 30 μm, the shape of the peripheral surface of the chill roll can influence not only on the shape of the roll surface of the alloy ribbon, but also on the shape of the free solidified surface of the alloy ribbon.

Accordingly, Equation (1) to Equation (5) relating to the shape of the free solidified surface of the alloy ribbon can be related to the feature of the polishing brush roll and the polishing conditions.

Next, the relationships between Equation (1) to Equation (5) and the discharge pressure of the molten alloy or the distance between the molten metal nozzle tip and the peripheral surface of the chill roll will be described.

The discharge pressure of a molten alloy or the distance between a molten metal nozzle tip and a peripheral surface of a chill roll have influence on the wave-like rugged shape of a free solidified surface. It is thought that the above discharge pressure and the above distance are related to the micro vibration of a puddle (a molten metal puddle). Further, it is thought that the micro vibration of the puddle is related to the wave-like rugged shape of the free solidified surface.

Accordingly, Equation (1) to Equation (5) relating to the shape of the free solidified surface of the alloy ribbon can be related also to the above discharge pressure and the above distance.

Hereinafter, a preferable range of an example of the production method will be described.

—Polishing Brush Roll—

As a polishing brush roll, it is preferable to use a polishing brush roll (for example, the polishing brush roll 60 described above) including a roll axis member and a polishing brush, which is composed of numerous brush bristles and is placed around the roll axis member.

It is preferable that the brush bristle that constitutes the polishing brush contains a resin.

When the brush bristle contains a resin, deep abrasions are less likely to occur on the peripheral surface of the chill roll. Therefore, for example, “(V_{A}/P_{A})<1.4” and “Rv≤3.0” tend to be easily satisfied.

The resin is preferably a nylon resin, such as Nylon 6, Nylon 612, or Nylon 66.

Further, the content of the resin in the brush bristle (the content of the resin with respect to the total amount of brush bristle; hereinafter the same applies.) is preferably 50% by mass or more, and more preferably 60% by mass or more. When the content of the resin in the brush bristle is 50% by mass or more, a phenomenon in which deep abrasions occur on the peripheral surface of the chill roll is further suppressed. Therefore, for example, “(V_{A}/P_{A})<1.4” and “Rv≤3.0” tend to be more easily satisfied.

The upper limit of the content of the resin in the brush bristle may be 100% by mass, but may be 60% by mass, 65% by mass, 75% by mass, or 80% by mass.

It is more preferable that the brush bristle contains inorganic polishing powder, in addition to the resin.

When the brush bristle contains inorganic polishing powder, the polishing power with respect to the peripheral surface of the chill roll is further improved. Therefore, “Rp≤3.0” and “0.9≤(V_{A}/P_{A})” tend to be more easily satisfied.

Further, when the brush bristle contains inorganic polishing powder, fine ruggedness is easily formed, due to polishing, on the peripheral surface of the chill roll. Therefore, for example, “7≤Pn” and “7≤Vn” tend to be more easily satisfied.

Examples of the inorganic polishing powder include alumina and silicon carbide.

The particle size of the inorganic polishing powder is preferably from 45 μm to 90 μm, and more preferably from 50 μm to 80 μm.

Here, “the particle size of the inorganic polishing powder” represents the size of a mesh opening of a sieve, through which the particles of inorganic polishing powder can pass. For instance, “the particle size of the inorganic polishing powder is from 45 μm to 90 μm” represents that the inorganic polishing powder passes through a mesh having an opening of 90 μm but does not pass through a mesh having an opening of 45 μm.

The content of the inorganic polishing powder in the brush bristle is preferably from 20% by mass to 40% by mass, and more preferably from 25% by mass to 35% by mass, with respect to the total amount of brush bristle.

When the content of the inorganic polishing powder is 20% by mass or more, for example, “0.9≤(V_{A}/P_{A})”, “7≤Pn”, and “7≤Vn” tend to be more easily satisfied.

When the content of the inorganic polishing powder is 40% by mass or less, incorporation of the polishing powder to a molten alloy is further suppressed, and defects in the alloy ribbon caused by the polishing powder are suppressed. Therefore, when the content of the inorganic polishing powder is 40% by mass or less, for example, “Rv≤3.0”, “Pn≤20”, and “Vn≤20” tend to be more easily satisfied.

The cross sectional shape of the brush bristle is not particularly limited, and examples include oval (including a round shape) and polygon (preferably, square).

The diameter of a circle circumscribing the cross section of the brush bristle is preferably from 0.5 mm to 1.5 mm, and more preferably from 0.6 mm to 1.0 mm.

In the brush bristle tip, the brush bristle density is preferably from 0.15 bristles/mm² to 0.45 bristles/mm².

When the brush bristle density is 0.15 bristles/mm² or more, the polishing power with respect to the peripheral surface of the chill roll is further improved and fine ruggedness is easily formed, due to polishing, on the peripheral surface. Therefore, for example, “0.9≤(V_{A}/P_{A})”, “7≤Pn” and “7≤Vn” tend to be more easily satisfied.

When the brush bristle density is 0.45 bristles/mm² or less, frictional heat radiation property at the time of polishing is excellent.

The diameter of the polishing brush roll may be, for example, from 100 mm to 300 mm, and is preferably from 130 mm to 250 mm.

The length in the axial direction of the polishing brush roll is set as appropriate in accordance with the width of the alloy ribbon to be produced.

—Conditions for Polishing Peripheral Surface of Chill Roll by Using Polishing Brush Roll—

The push-in amount of the polishing brush (brush bristle) with respect to the peripheral surface of the chill roll is adjusted as appropriate. The push-in amount can be set to be, for example, from 2 mm to 10 mm.

The speed of the polishing brush relative to the speed of the chill roll is preferably from 10 m/s to 20 m/s.

When the relative speed is 10 m/s or more, the polishing power with respect to the peripheral surface of the chill roll is further improved and fine ruggedness is easily formed, due to polishing, on the peripheral surface. Therefore, for example, “7≤Pn” and “7≤Vn” tend to be more easily satisfied.

The relative speed being 20 m/s or less is advantageous in terms of reduction of frictional heat at the time of polishing.

The relative speed is more preferably from 12 m/s to 17 m/s, and still more preferably from 13 m/s to 18 m/s.

Here, in a case in which the rotational direction of the polishing brush roll is opposite to the rotational direction of the chill roll (for example, in the case of FIG. 1), the speed of the polishing brush relative to the speed of the chill roll means the absolute value of the difference between the rotation speed (absolute value) of the polishing brush roll and the rotation speed (absolute value) of the chill roll.

Meanwhile, in a case in which the rotational direction of the polishing brush roll and the rotational direction of the chill roll are identical, the speed of the polishing brush relative to the speed of the chill roll means the sum of the rotation speed (absolute value) of the polishing brush roll and the rotation speed (absolute value) of the chill roll.

—Discharge Pressure of Molten Alloy—

The discharge pressure of the molten alloy is preferably from 10 kPa to 25 kPa, and more preferably from 15 kPa to 20 kPa, from the viewpoint that the roughness curve is likely to satisfy Equation (1) to Equation (5).

As the discharge pressure gets higher (for example, when the discharge pressure is 10 kPa or more), “(V_{A}/P_{A})<1.4” tends to be easily satisfied. It is thought that the reason for this is as follows: as the discharge pressure gets higher, the amount of a molten alloy supplied to a puddle (for example, the puddle 22B) per unit of time becomes larger, and as a result, vibration of the puddle is suppressed.

—Distance Between Molten Metal Nozzle Tip and Peripheral Surface of Chill Roll—

The distance between the molten metal nozzle tip and the peripheral surface of the chill roll is preferably from 0.2 mm to 0.4 mm.

As the distance between the molten metal nozzle tip and the peripheral surface of the chill roll gets smaller (for example, when the distance is 0.4 mm or less), “(V_{A}/P_{A})<1.4” tends to be easily satisfied. It is thought that the reason for this is as follows: as the above distance gets smaller, the volume of a puddle (for example, the puddle 22B) becomes smaller, and as a result, vibration of the puddle is suppressed.

### EXAMPLES

The invention will be specifically described below by way of Examples, provided that the invention is not limited to the following Examples.

### Examples 1 to 6, Comparative Examples 1 and 2

<Production of Fe-Based Amorphous Alloy Ribbon>

An alloy ribbon production apparatus having a configuration similar to that of the alloy ribbon production apparatus 100 shown in FIG. 1 was prepared.

As the chill roll, a chill roll having a diameter of 400 mm, in which the material of the peripheral surface is a Cu—Ni alloy and an arithmetic average roughness Ra of the peripheral surface is 0.3 μm, was used.

First, a molten alloy including Fe, Si, B, and impurities (hereinafter also referred to as an “Fe—Si—B-base molten alloy”) was prepared in a crucible. Specifically, pure iron, ferrosilicon, and ferroboron were mixed and melted, to prepare a molten alloy in which the content of Fe is 80.5 atom %, the content of Si is 7.2 atom %, the content of B is 12.3 atom %, and the content of C is 0.3 atom % or less when the total content of Fe, Si, and B is 100 atom %, with the remainder consisting of impurities. These numerical values of atom % are values obtained by extracting a portion of the alloy from the molten metal and performing measurement according to ICP (inductively coupled plasma) optical emission spectrophotometry.

Next, the Fe—Si—B-base molten alloy was discharged from a molten metal nozzle having a rectangular (slit shape) opening with a long side length of 142 mm and a short side length of 0.6 mm, through the opening onto the peripheral surface of the rotating chill roll for rapid solidification, to produce (cast) 3000 kg of an amorphous alloy ribbon having a ribbon width of 142 mm and a thickness of 24 μm. The casting time was 80 minutes and the alloy ribbon was casted continuously without any breakage (also in all of the examples of Example 2 or later described below, an alloy ribbon was casted continuously without any breakage).

The above casting was performed while polishing the peripheral surface of the chill roll by using a polishing brush (brush bristles) of a polishing brush roll. This polishing was performed such that the polishing brush of the polishing brush roll was brought into contact with the peripheral surface of the chill roll at the entire region in the width direction. The molten alloy was discharged onto the peripheral surface of the chill roll that had been polished (see FIG. 1).

Detailed conditions for the above casting are shown below.

—Casting Conditions—

Temperature of molten alloy: 1300° C.

Circumferential speed of chill roll: 25 m/s

Discharge pressure of molten alloy: adjusted within the range of from 15 kPa to 20 kPa

Distance (gap) between molten metal nozzle tip and peripheral surface of chill roll: adjusted within the range of from 0.25 mm to 0.35 mm

Further, as the polishing brush roll, a polishing brush roll that includes brush bristles comprising Nylon 612 (70% by mass) as the resin and silicon carbide (30% by mass) as the inorganic polishing powder was used.

The polishing brush roll and the polishing conditions are as follows.

—Polishing Brush Roll—

Particle size of silicon carbide in brush bristle (polishing brush): from 60 μm to 90 μm

Cross sectional shape of brush bristle: a round shape having a diameter of 0.8 mm

Size of polishing brush roll: diameter 150 mm×length in the axial direction 300 mm

Brush bristle density at brush bristle tip: 0.27 bristles/mm²

—Polishing Conditions—

Speed of polishing brush relative to speed of chill roll: adjusted within the range of from 11 m/s to 17 m/s

Relationship between rotational direction of polishing brush roll and rotational direction of chill roll: opposite direction (at the contact portion, a specific point in the peripheral surface of the chill roll and a specific brush bristle of the polishing brush roll move toward the same direction)

<Measurement of Roughness Curve>

With regard to a central part in the ribbon width direction of the free solidified surface of the alloy ribbon after elapse of about 50 minutes from the initiation of casting, a roughness curve was measured according to JIS B 0601:2013 by applying 20 mm in the ribbon length direction as a reference length and taking 0.8 mm as a cut-off value.

Measurement of a roughness curve was performed using a SURFCOM 2000DX (trade name, manufactured by TOKYO SEIMITSU CO., LTD.) as a surface roughness meter, under the condition of a scanning speed of 0.6 mm/s.

From the roughness curve thus obtained, Rp, Rv, Pn, Vn, V_{A}, P_{A}, and (V_{A}/P_{A}) were determined, respectively. Rp, Rv, Pn, Vn, V_{A}, and P_{A} are as described above.

The results are shown in Table 1.

In Examples 1 to 6 and Comparative Examples 1 and 2, Rp, Rv, Pn, Vn, V_{A}, and P_{A} were adjusted by adjusting the discharge pressure of the molten metal, the distance between the molten metal nozzle tip and the peripheral surface of the chill roll, and the speed of the polishing brush relative to the speed of the chill roll within the ranges described above, respectively.

<Measurements of Excitation Power and Core Loss>

With regard to the alloy ribbon in each of Examples 1 to 6 and Comparative Examples 1 and 2, the excitation power and the core loss were measured, respectively.

The excitation power and the core loss were measured in accordance with ASTM A932/A923M-01.

The results are shown in Table 1.

### Examples 101 and 102, Comparative Examples 101 and 102

Operations were conducted similar to those in Example 1, except that the following points were changed. The results are shown in Table 1.

### Changes from Example 1

The molten metal nozzle was changed to a molten metal nozzle having a rectangular (slit shape) opening with a long side length of 213 mm and a short side length of 0.6 mm.
The casting time was changed to 90 minutes, to produce (cast) 4000 kg of an amorphous alloy ribbon having a ribbon width of 213 mm and a thickness of 24 μm.
The circumferential speed of the chill roll was changed to 23.5 m/s.
The speed of the polishing brush relative to the speed of the chill roll was adjusted within the range of from 10 m/s to 14 m/s.
The resin in the brush bristle was changed to Nylon 6.
The particle size of silicon carbide in the brush bristle was changed to a particle size of from 45 μm to 80 μm.
The cross sectional shape of the brush bristle was changed to a round shape having a diameter of 1.0 mm.
The brush bristle density at the brush bristle tip was changed to 0.23 bristles/mm².

### Example 201, Comparative Examples 201 and 202

Operations were conducted similar to those in Example 1, except that the following points were changed. The results are shown in Table 1.

### Changes from Example 1

The molten alloy was changed to a molten alloy in which the content of Si is 3.8 atom %, the content of B is 14.5 atom %, and the content of C is 0.2 atom %, with the remainder consisting of Fe and impurities.
The molten metal nozzle was changed to a molten metal nozzle having a rectangular (slit shape) opening with a long side length of 170 mm and a short side length of 0.6 mm.
The casting time was changed to 64 minutes, to produce (cast) 3000 kg of an amorphous alloy ribbon having a ribbon width of 170 mm and a thickness of 24 μm.
The speed of the polishing brush relative to the speed of the chill roll was adjusted within the range of from 11 m/s to 16 m/s.

TABLE 1

| | | | | | | | | | | | Excitation |
|---|---|---|---|---|---|---|---|---|---|---|---|
| | Thickness | Width | Rp | Rv | | | P_{A} | V_{A} | | Core loss | power |
| | (μm) | (mm) | (μm) | (μm) | Pn | Vn | (μm) | (μm) | V_{A}/P_{A} | (W/kg) | (VA/kg) |
| Example 1 | 24 | 142 | ≤3.0 | ≤3.0 | 17 | 16 | 1.3 | 1.4 | 1.1 | 0.084 | 0.161 |
| Example 2 | 24 | 142 | ≤3.0 | ≤3.0 | 17 | 24 | 1.1 | 1.3 | 1.2 | 0.081 | 0.161 |
| Example 3 | 24 | 142 | ≤3.0 | ≤3.0 | 15 | 22 | 1.2 | 1.4 | 1.2 | 0.084 | 0.146 |
| Example 4 | 24 | 142 | ≤3.0 | ≤3.0 | 14 | 13 | 1.2 | 1.4 | 1.2 | 0.087 | 0.152 |
| Example 5 | 24 | 142 | ≤3.0 | ≤3.0 | 8 | 9 | 1.2 | 1.4 | 1.2 | 0.091 | 0.166 |
| Example 6 | 24 | 142 | ≤3.0 | ≤3.0 | 10 | 14 | 1.4 | 1.6 | 1.1 | 0.088 | 0.157 |
| Comparative | 24 | 142 | ≤3.0 | ≤3.0 | 6 | 5 | 0.7 | 0.9 | 1.3 | 0.131 | 0.265 |
| Example 1 | | | | | | | | | | | |
| Comparative | 24 | 142 | ≤3.0 | ≤3.0 | 12 | 11 | 1.6 | 2.4 | 1.5 | 0.094 | 0.203 |
| Example 2 | | | | | | | | | | | |
| Example 101 | 24 | 213 | ≤3.0 | ≤3.0 | 17 | 16 | 1.5 | 1.5 | 1.0 | 0.081 | 0.196 |
| Example 102 | 24 | 213 | ≤3.0 | ≤3.0 | 14 | 13 | 1.5 | 1.4 | 0.9 | 0.082 | 0.179 |
| Comparative | 24 | 213 | ≤3.0 | ≤3.0 | 5 | 3 | 0.7 | 0.6 | 0.9 | 0.145 | 0.236 |
| Example 101 | | | | | | | | | | | |
| Comparative | 24 | 213 | ≤3.0 | ≤3.0 | 12 | 18 | 1.3 | 2.1 | 1.6 | 0.085 | 0.516 |
| Example 102 | | | | | | | | | | | |
| Example 201 | 25 | 170 | ≤3.0 | ≤3.0 | 9 | 8 | 1.2 | 1.2 | 1.0 | 0.089 | 0.188 |
| Comparative | 25 | 170 | ≤3.0 | ≤3.0 | 4 | 5 | 0.9 | 1.0 | 1.1 | 0.148 | 0.268 |
| Example 201 | | | | | | | | | | | |
| Comparative | 25 | 170 | ≤3.0 | ≤3.0 | 10 | 13 | 1.8 | 2.5 | 1.4 | 0.092 | 0.277 |
| Example 202 | | | | | | | | | | | |

As shown in Table 1, with regard to the alloy ribbon in each Example, in which Equation (1) to Equation (5) are satisfied, the excitation power was reduced and the core loss was also reduced.

In contrast, with regard to the alloy ribbons of Comparative Examples 1, 101, and 201, in which Pn is less than 7 and Vn is less than 7, the excitation power was high and the core loss was also high.

Further, with regard to the alloy ribbons of Comparative Examples 2, 102, and 202, in which (V_{A}/P_{A}) is 1.4 or more, the excitation power was high.

FIG. 2 to FIG. 4 are a roughness curve of Example 1 (FIG. 2), a roughness curve of Comparative Example 1 (FIG. 3), and a roughness curve of Comparative Example 2 (FIG. 4), respectively.

As shown in FIG. 2, in the roughness curve of Example 1, in which Equation (1) to Equation (5) are satisfied, it is understood that a certain degree of definite (moderate) rugged shape exists.

In the roughness curve of Comparative Example 1, shown in FIG. 3, in which Pn is less than 7 and Vn is less than 7, it is understood that the degree of ruggedness in the rugged shape is small as compared to FIG. 2.

Further, in the roughness curve of Comparative Example 2, shown in FIG. 4, in which (V_{A}/P_{A}) is 1.4 or more, it is understood that the depths of profile valleys are too deep as a whole as compared to FIG. 2.

Consequently, it is confirmed that, in a case in which the free solidified surface of the alloy ribbon has a certain degree of definite (moderate) rugged shape, the excitation power is reduced.

The disclosure of Japanese Patent Application No. 2015-230817 is incorporated by reference herein in its entirety.

All publications, patent applications, and technical standards mentioned in this specification are herein incorporated by reference to the same extent as if such individual publication, patent application, or technical standard was specifically and individually indicated to be incorporated by reference.

1. An Fe-based amorphous alloy ribbon having a free solidified surface, wherein:
the ribbon has a thickness of from 10 μm to 30 μm, and
a roughness curve for a central part in the ribbon widthwise direction of the free solidified surface satisfies the following Equation (1) to Equation (5), the roughness curve being measured according to JIS B 0601:2013 by applying 20 mm in a ribbon lengthwise direction as the reference length and taking 0.8 mm for a cut-off value:
Rp≤3.0 Equation (1)
Rv≤3.0 Equation (2)
7≤Pn≤30 Equation (3)
7≤Vn≤30 Equation (4)
0.9≤(V_{A}/P_{A})<1.4 Equation (5)
wherein, in Equation (1), Rp represents the maximum profile peak height (μm), in Equation (2), Rv represents the maximum profile valley depth (μm), in Equation (3), Pn represents the number of profile peaks which are included in the roughness curve and have a height of from 0.5 μm to 3.0 μm, in Equation (4), Vn represents the number of profile valleys which are included in the roughness curve and have a depth of from 0.5 μm to 3.0 μm, and in Equation (5), P_{A} represents an average (μm) of heights of five profile peaks from the highest profile peak to the fifth highest profile peak, and V_{A} represents an average (μm) of depths of five profile valleys from the deepest profile valley to the fifth deepest profile valley.

2. The Fe-based amorphous alloy ribbon according to claim 1, wherein V_{A} is from 1.1 μm to 2.0 μm.

3. The Fe-based amorphous alloy ribbon according to claim 1, having a width of from 100 mm to 500 mm.

4. The Fe-based amorphous alloy ribbon according to claim 1, wherein a content of Si is from 3 atom % to 10 atom %, a content of B is from 10 atom % to 15 atom %, and a content of C is 0.5 atom % or less when a total content of Fe, Si, and B is 100 atom %, with the remainder consisting of Fe and impurities.

5. The Fe-based amorphous alloy ribbon according to claim 2, having a width of from 100 mm to 500 mm.

6. The Fe-based amorphous alloy ribbon according to claim 5, wherein a content of Si is from 3 atom % to 10 atom %, a content of B is from 10 atom % to 15 atom %, and a content of C is 0.5 atom % or less when a total content of Fe, Si, and B is 100 atom %, with the remainder consisting of impurities.
